(19) United States
(12) Patent Application Publication
(10) Pub. No.: US 2012/0090409 A1
(43) Pub. Date: Apr. 19, 2012

(54) FORCE-SENSING DEVICE FOR MEASURING FORCE ON SOLID STATE ACTUATORS, METHOD FOR MEASURING FORCE, AS WELL AS USE OF FORCE-SENSING DEVICE

(76) Inventors: Holger Luthje, Halstenbek (DE); Saskia Biehl, Saarbrucken (DE); Dirk Mayer, Darmstadt (DE); Tobias Melz, Darmstadt (DE); Sven Herold, Darmstadt (DE)

(21) Appl. No.: 12/298,035

(22) PCT Filed: Apr. 27, 2007
(86) PCT No.: PCT/EP07/03776

§ 371 Date: Sep. 29, 2009

(30) Foreign Application Priority Data
Apr. 28, 2006 (DE) 10 2006 019 942.1

(51) Int. Cl. G01L 1/22

(52) U.S. Cl. 73/862.627

(57) ABSTRACT

The present invention relates to a force measuring device comprising an amorphous carbon layer which is disposed on a solid actuator and has piezoresistive properties.

Solid actuators, e.g. piezoactuators, in particular in the form of piezoelectric stack actuators but also magnetostrictive or electrostrictive actuators, are essential controllers of innovative active, particularly adaptronic systems and have a large potential for distribution. A known field of application for piezoactuators is modern injection systems, e.g. for Common Rail Diesel vehicles. An unresolved problem with these actuators which at present hinders further applications is the lack of knowledge of the current force in the direction of action which the actuator applies or experiences in the respective application. The use of mechanically series-connected force sensor modules based on (DMS) wire strain gauges or piezoceramic force sensors leads to additional mass or constructional volume and/or elasticity and costs. Conventional piezoelectric sensors cannot in addition be used in the case of static measurements and hence do not allow measurement of the frequently desired mechanical pre-loading adjustment of the actuator. The use of a disc of a stack actuator (state of the art) entails the disadvantage that, in addition to the force measurement in the actuator direction of action, also transverse strain components are jointly detected and falsify the measurement. A compact force measurement which acts statically to highly dynamically with very high rigidity would be advantageous.

Piezoactuators are offered for sale at present for different requirements. The elongation is thereby measured partially with laterally glued-on DMS. A force measurement can only be effected by load cells which are incorporated in addition in series in the force flow or strain sensors which are connected in series or in parallel. For laboratory designs, for example also piezoelectric force measuring foils for example were used. However, in particular a low loading capacity and also high wear and tear are thereby disadvantageous.

Piezoelectric sensors made of ceramic plates or fibres are also known, likewise accommodated or configured as semi-finished objects. However it is hereby disadvantageous that no static measurements can be implemented.

Furthermore, piezoresistive sensors are used according to the elongating-upsetting principle (on deformable basic bodies).

Adaptronic and mechatronic systems are frequently designed on the basis of solid, frequently piezoelectric, actuators. Examples are mentioned in the patent specifications DE 195 27 514 (interface for vibration reduction in structural-dynamic systems) and DE 101 17 305 (method for reducing noise transmission in vehicles, chassis for vehicles and actuators.

For high-dynamic active operation, e.g. high-dynamic testing of small components with a static pre-load, in particular force sensors are of interest, which can at the same time measure static and dynamic forces. Since force sensor systems are situated directly in the force flow, they should in addition have high rigidity in order to transmit actuator thrust and force optimally from the actuator to the test body.

Force sensors are already commercially available in various constructions and according to various measuring principles. Piezoelectric force sensors (e.g. Kistler Instrumente AG Winterthur: Quartz measuring washers 9001A-9071A, Kistler Instrumente AG Winterthur, data sheet, Winterthur, 2004) are very sensitive, have relatively high rigidity and are obtainable in a compact form but, because of the measuring principle (load measurement), are only suitable for measuring dynamic forces. Alternatively thereto, force sensors exist based on wire strain gauges (e.g. HBM GmbH: U9B—Force Transducer, Hottinger Baldwin Messtechnik GmbH, data sheet, Darmstadt, 2004; HBM GmbH: Z30—Force Transducer). These are also suitable for measuring static forces but have only low inherent rigidity. Furthermore, all commercially available sensors have a non-negligible mass which makes application in high-dynamic testing technology difficult.

Some documents deal with the actuation of piezoactuators, such as e.g. the publications U.S. Pat. No. 5,578,761 (Adaptive Piezoelectric Sensoriactuator) and U.S. Pat. No. 4,491,759 (Piezoelectric Vibration Exciter, Especially for Destructive Material Testing).

Only a few publications deal with the integration of a force sensor system into the actuator system. In this respect, e.g. the patent specification U.S. Pat. No. 5,347,870 (Dual Function System Having a Piezoelectric Element) is of relevance. Also the actuator is thereby used at the same time as sensor. However this does not enable static measurements and pre-tensions. A surface-integrated force sensor system based on hard, very thin DLC (Diamond-Like Carbons) layers, which is the subject-matter of the present invention, is however not proposed in any of these works. Advantages are therefore the resulting very high rigidities of the force sensor system which avoid loss of elongation of the actuator.

The production of layers can be effected by means of conventional plasma-PVD and/or plasma CVD methods or by a combination of both methods.

Commercially available multi-target sputter plants or plasma CVD plants can be used for this purpose.

A more detailed description relating to the state of the art is found in the following patent specifications: DE 199 54 164 (use as force sensor), DE 102 43 095 (roller bearings), DE 102 17 284 (device for frictional connections), DE 102 53 178 (multifunction layer for force and temperature measurements).

The previously known uses of the amorphous carbon layer with multifunctional properties do not disclose any applications as force sensor in the case of solid actuators.

Increasing miniaturisation not only of electronic but in particular also of mechanical components leads to the necessity to examine also the lifespan and reliability thereof with corresponding methods and to evaluate them in order thus to optimise the development processes. In addition, vibration problems including measures for active control for reducing vibrations are increasingly receiving attention since these delimit the manufacturing tolerances, metrological solutions, lifespan and comfort which can be achieved with commercial methods. For this purpose, an essentially broader frequency range relative to standard design methods must be considered, the force sensor according to the invention being formed from a thin, low-mass carbon layer and having great advantages relative to the state of the art.

Both for experimental operating load simulation in the higher frequency range and also the active control of vibrations as far as the structurally acoustic range, concepts for controlled mechanical force introduction are becoming more and more important. There are suitable for this purpose solid actuators, very frequently piezoceramic stack actuators which can generate static to high-dynamic loads. For a controlled operation, for example vibration damping, the measurement of the acting or introduced force is of substantial significance. This force measurement is effected advantageously directly on/in the actuator, i.e. situated directly in the force flow. A very high rigidity of the sensor is hereby indispensable since elasticity in the load path corresponds to a reduction in the effectiveness of the actuator which must be avoided. At the same time, the force measurement is intended to be produced from static to high-dynamic in order to be able to measure both mechanical pre-tension loads and also operating loads. Known solutions such as also capacitive or piezoceramically-based force sensors are less and less rigid relative to the DLC layer solution. In addition, the measurement of static loads with piezoceramic solutions is not achievable.

The solution to the measurement of forces by means of using a piezoceramic layer, as described in the state of the art, entails the disadvantage in addition that the axial force measurement is falsified by transverse contraction effects.

Starting herefrom, it was the object of the present invention to provide a force sensor which does not have the described disadvantages.

The object is achieved by the force measuring device having the features of claim 1. Likewise, a method for measuring a force having the features of claim 25 is provided. Furthermore, the use of the thin film sensor according to the invention is described in claim 33. The dependent claims respectively mention the advantageous developments.

According to the invention, a novel force measuring device is proposed which comprises an amorphous carbon layer which is disposed on a carrier and has piezoresistive properties (piezoresistive layer).

Advantageously, the carrier is a solid actuator which is configured above all as a piezoelectric stack actuator.

The carrier can be present in addition e.g. in the form of a metallic carrier, preferably a steel carrier or a ceramic carrier. For example, a ceramic ring coated with metal, a steel ring or a metallic foil can be used if it is wished to measure the load over the entire surface.

In an advantageous embodiment, the carrier can also be configured as an electromagnetic, hydraulic and/or pneumatic actuator.

Amongst amorphous carbon layers in the sense according to the invention there will be layers made of amorphous carbon both with and without hydrogen. According to DE 199 54 164, layers of this type which comprise amorphous carbon are known, e.g. with the descriptions a-C, a-:CH, i-CH, a-C:H:Me, DLC (diamond-like carbons), Me:DLC. Preferably, the amorphous carbons are configured as multifunctional layers and contain a-C, a-:CH, CH, a-C:H:Me, DLC, Me:DLC and/or mixtures hereof.

Diamond-like hydrocarbons (DLC) are particularly advantageous because of the high hardness thereof. By applying diamond-like hydrocarbons as a thin layer, a measurement of normal forces is surprisingly made possible practically without changing the rigidity of the system. Hence force measuring devices can be constructed, which are produced for example as a force/pressure sensor with extremely high rigidity of less than 10 nm/kN and excellent tribological properties. These tribological properties can be quantified in particular by high wear-resistance (2′10⁻¹⁵ to 10′10⁻¹⁵ m³/Nm; in contrast thereto, hardened steel (100Cr6) has approx. a 100 times higher wear value (220′10⁻¹⁵ m³/Nm)) and a high thermal stability (up to at least 150° C., preferably at least 200° C.).

According to the invention, also layers with partially sp³-bonded carbon with and without additives/dopings made of metals, silicon, fluorine, boron, germanium, oxygen can be used.

The amorphous carbon layers preferably have a hardness of at least 10 GPa, particularly preferred of at least 15 GPa and are applied in the thickness range of 0.1 to 30 μm, preferably in the thickness range of to 10 μm.

A further advantage of the multifunctional, amorphous carbon layers resides in the fact that they are distinguished by very advantageous tribological properties and also a high mechanical wear resistance and can be loaded thermally up to at least 150° C., preferably up to at least 200° C.

In an alternative embodiment, a metal layer can be applied in addition in the case of electrically insulating carrier materials between the carrier and the amorphous carbon layer. The metal layer hence enables electrical contacting for determining electrical variables such as voltage and/or current strength, and finally in addition the determination of the resistance of the amorphous carbon layer.

The applied thickness of the metal layer thereby extends between 50 and 500 nm. Fundamentally, all electrically conductive materials can be used for the coating, but preferably metals (above all transition metals) and/or semi-metals and/or alloys herefrom are used preferably.

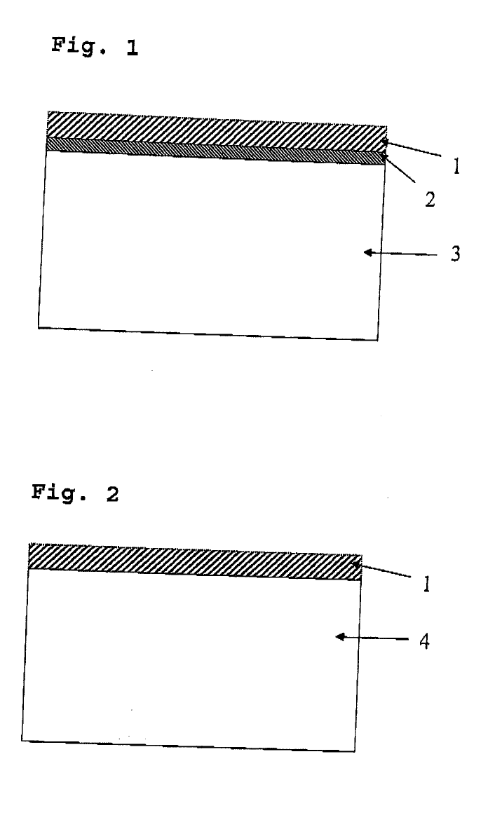

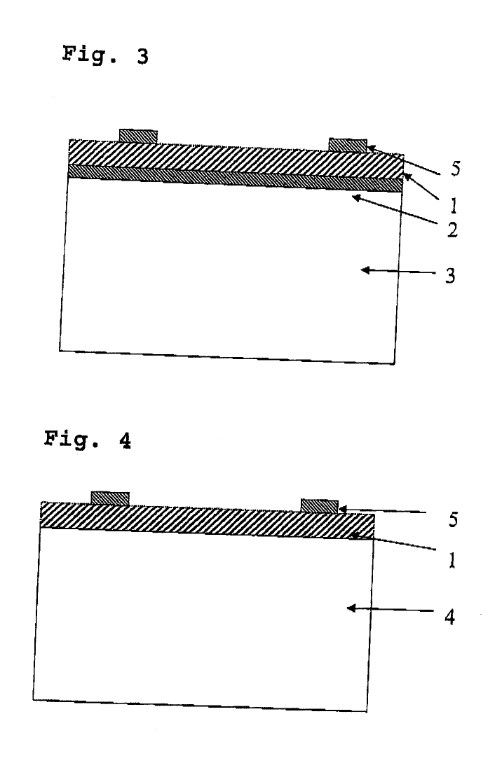

This embodiment is possible above all for the sensor construction, based on a ceramic carrier (cf. FIGS. 1 and 3). The piezoresistive layer is deposited on the upper side of the metal layer.

In a further embodiment, the force measuring device has in addition, between the substrate and the piezoresistive layer, an insulation layer and/or a wear protection layer which can contain materials, such as e.g. MN or Al₂O₃. The layer thickness of the insulation layer and/or wear protection layer is thereby dimensioned between 0.5 and 500 μm, preferably between 2 and 10 μm.

This embodiment is advantageous above all if a metallically conducting carrier, for example a steel carrier, is used. An embodiment by way of example is represented in FIGS. 2 and 4.

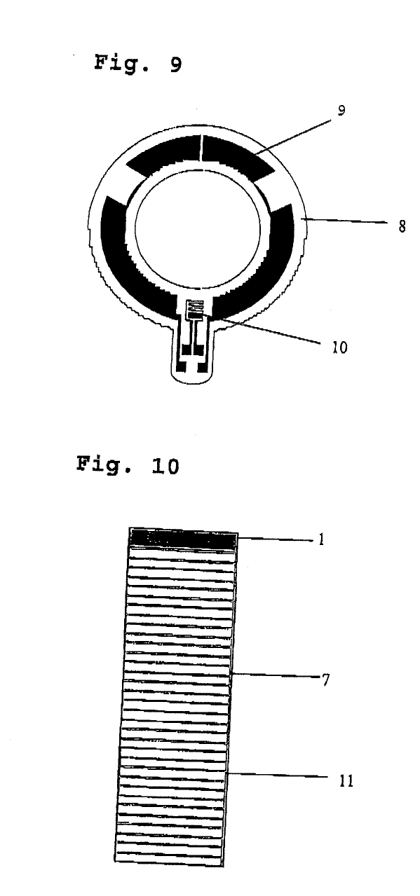

Furthermore, the possibility exists of a further embodiment of the force measuring device in which local electrode structures are applied in addition on the piezoresistive sensor layer (see also FIGS. 3 to 5). These can also be applied in the form of a foil, as represented in FIGS. 8 and 9.

Furthermore, it can be advantageous if at least one temperature sensor is integrated in addition into the force measuring device. Hence above all in the case of measurements of high-dynamic forces, i.e. temporally rapidly changing forces, the temperature characteristics of the force measuring device, i.e. the influence of the temperature on the electrical resistance of the amorphous carbon layer, can be taken into account.

The previously described force measuring devices can in principle adopt any geometric embodiment, the form of a ring is particularly preferred.

According to the invention, a method is likewise provided for measuring a force with the help of the force measuring device.

Measurements both of dynamic and static forces are now possible due to the construction according to the invention of the force measuring device. Hence, an application of solid actuators which extends far beyond the state of the art is surprisingly made possible. For high-dynamic measurements, the advantage of this force sensor resides in the fact that a measurement can be implemented with high precision via the layer applied directly on the piezoactuator. Since the layer comprises for the most part carbon as a very light element, a further advantage resides in the fact that the piezoresistive layer is very low-mass.

The measurement of the current force acting on the force measuring device is effected with the help of a resistance measurement of the piezoresistive layer. In the measurement, the current flow is effected through the sensor layer and is tapped for example on a wire which is contacted in the edge region of the metal layer.

In another embodiment, the current flow used for the resistance measurement of the piezoresistive layer can also be tapped via the steel carrier.

The measurement of the force can thereby be measured, according to the embodiment of the force sensor, over the entire surface—i.e. integrally—or with local resolution. Measurements with local resolution can be made possible by introducing local electrode structures on the sensor layer.

The typical piezoresistive behaviour of the amorphous carbon layer with full-surface loading is represented in FIG. 6. The loading and unloading cycles characteristic of the sensor layer with full-surface contacting of the sensor layer can be detected therein, said cycles having very good reproducibility.

In addition to the force measurement, the temperature in the contact surface must also be measured in particular with high-dynamic measurements. This measurement serves, on the one hand, for compensation of the temperature characteristic of the force sensor but also for controlling and optimising the actuation of the actuator. Consequently, the dependency of the resistance of the piezoresistive layer upon the temperature can be effectively compensated for. Temperature variations can occur at increased pressures. On the other hand however, also a possibility for using the force measuring device over a wide temperature range is hence made possible.

According to the invention, possibilities for application of the force measuring devices are likewise provided. The diamond-like force-sensoring layers proposed here allow the construction of active structure interfaces, pre-tension-controlled roller bearings, retaining force controls, machine tools, printing rollers, damping devices or adjustment devices.

An application in active vibration damping systems is also conceivable.

A method for the production of a force measuring device is likewise provided according to the invention. In the method, local electrode structures which are pre-structured on a foil and/or the temperature sensors are incorporated in the force sensor.

The invention, the use thereof and also the methods according to the invention for measuring a force and also for producing the invention are intended to be explained in more detail with reference to Figures, explained below, and also to the description by way of example, without restricting the invention to the represented examples.

FIG. 1 shows an annular embodiment of the force measuring device according to the invention, having a ceramic actuator ring 3 as substrate, a metal layer 2 applied thereon and also a piezoresistive layer applied thereon.

FIG. 2 likewise shows an annular embodiment of the force measuring device according to the invention, having a steel carrier 4 as substrate and a piezoresistive layer 1 applied thereon.

FIG. 3 shows an annular embodiment of the force measuring device according to the invention, represented as in FIG. 1, having additionally applied local electrode structures 5.

FIG. 4 shows an annular embodiment of the force measuring device according to the invention, as represented in FIG. 2, having additionally applied local electrode structures 5.

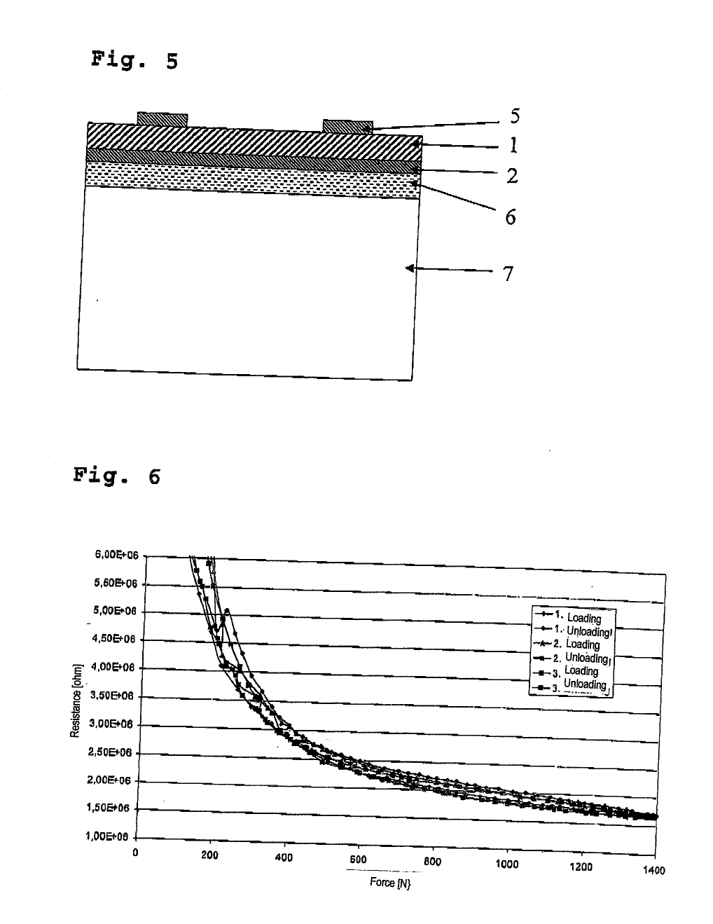

FIG. 5 shows an embodiment of the force measuring device according to the invention, based on a PZT element 7 with an additional insulation layer and/or wear protection layer 6 and also a homogeneous metal layer 2, piezoresistive sensor layer and local electrode structures 5.

FIG. 6 shows typical measurement curves of the resistance measurement as a function of the force acting with full-surface loading of the sensor.

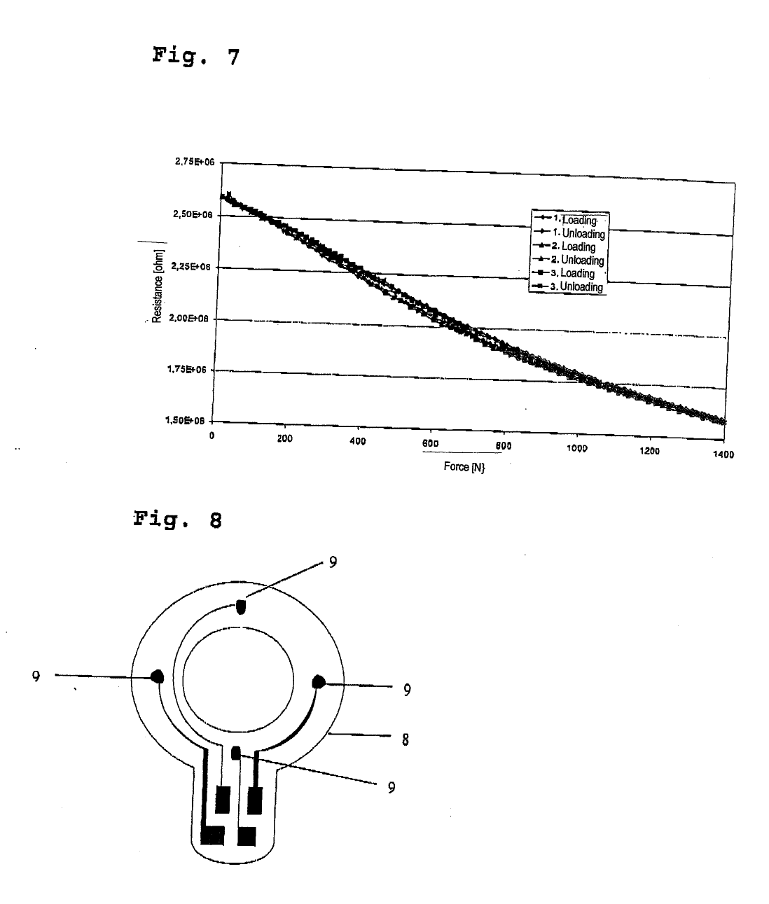

FIG. 7 shows typical measurement curves of the resistance measurement as a function of the force acting with locally structured loading of an embodiment of the sensor with local electrode structures.

FIG. 8 shows a foil 8, having local, pre-structured electrode structures 9 which allow a local measurement of the force.

FIG. 9 shows a foil 8, with local electrode structures 9 and an integrated temperature sensor 10.

FIG. 10 shows an actuator-sensor unit, comprising a piezoresistive sensor layer 1 and a piezoelectric stack actuator 7; both components are located in a housing 11.

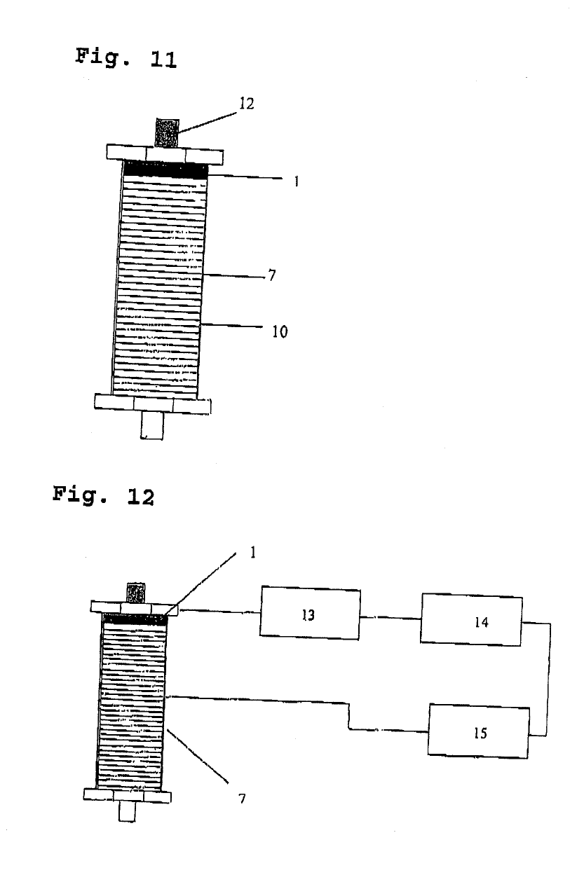

FIG. 11 likewise shows an actuator-sensor unit as in FIG. 10, another screw being present here in addition for adjusting the pre-tension 12 of the unit.

FIG. 12 shows the actuator-sensor unit as in FIG. 11 in a self-regulating system. For this purpose, the measurement signal produced by the piezoresistive sensor layer is initially pre-amplified in a measurement amplifier 13 in order then to be further processed in an integrated amplifier 14. For control of the piezoelectric stack actuator 7, the signal is finally further amplified in a power amplifier 15.

It is possible to construct the force measuring device on a carrier comprising ceramic material 3, a piezoelectric stack actuator element 7 or metal, for example steel 4 (FIGS. 1 to 5). Steel as base material has the advantage that the coating step with metal can be dispensed with. The ring can be covered directly with the sensing hydrocarbon layer 1 in order to pick up the forces integrally. Structured electrodes 5 could also be applied on the sensor layer in order to measure the forces or pressures with local resolution.

Since actuator elements can also already have a metal layer 2 on the surface, a sensor construction can also have an appearance such that an insulation layer and/or wear protection layer 6 is applied firstly on the PZT substrate (FIG. 5). This can be for example AlN or Al₂O₃. Consequently, the sensor construction is decoupled from the potential applied to the actuator stack. A metal layer 2 can be deposited thereon homogeneously. The piezoresistive layer 1 is subsequently applied thereon. In the case of a homogeneous base coating with metal 2, individual local electrodes 5 must be deposited on the sensor layer if pressure measurements with local resolution are intended to be implemented. An integral measurement of the force is effected without these top electrodes 5.

As an alternative, it is also possible to coat the structured sensor ring directly with an insulation and wear protection layer 6. The layer thickness for this protection layer is in the range of a few micrometres and confers the additional advantage that no further element need be integrated in the actuator construction.

The force sensors (e.g. from FIGS. 1 and 2) can be loaded over the entire surface in order to determine the forces acting thereon. The force is hence determined integrally. A non-linear dependency of the resistance of the piezoresistive sensor layer is thereby produced as a function of the acting force (FIG. 6).

Since many multifunctional solid actuators, such as e.g. ceramic piezoactuators, can only pick up pressure loads, it is also sensible in the case of larger actuators, in addition to the integral measurement of the force, to determine the force distribution on the surface and possibly the introduction of torques and to avoid the build-up of dangerous shear forces and local load peaks by control technology.

It can be detected in FIG. 7 that, as a result of locally applied electrode structures, the result is linearisation of the measurement curve. In an embodiment, by way of example, as represented in FIG. 3, the current flows over the electrode 5 through the sensor layer 1 and is tapped on the metal layer 2. An uncoated ceramic ring 3 can be used as counter-body.

A way apart from direct deposition of local electrode structures 5 on the sensor layer 1 for force measurement with local resolution is the incorporation of a foil 8. This foil 8 has local electrode structures on its surface. A possible design is represented in FIG. 8. The design of the structures can be adapted rapidly to the measurement task since these structured foils can be produced by the lift-off process. Integration of a temperature sensor 10 on the foil is likewise possible (FIG. 9).

These foils can be applied on a ring in direct contact with a simple homogeneously coated sensor layer 1 without being connected to said ring. The possibility is then offered of incorporating different foils in one actuator and exchanging these respectively according to the measurement task. However these structured plastic material foils 8 or 9 can also be connected to two rings to form an encapsulated sensor system. Only the ring with the sensor layer 1 is thereby covered and is in contact with the metallic electrode structures 5. The second ring can be uncoated.

Force-controlled piezoactuators make possible innovative adaptronic systems. Examples are active structure interfaces (cf. DE 103 614 81 or DE 102 004 019 2) which are intended to control the structure-borne noise flow when mounting units, or pre-tension-controlled roller bearings which lead for example to an improvement in accuracy with tool spindles. Furthermore, applications are conceivable in robotics/assembly, e.g. in retaining force controls, with machine tools, e.g. for monitoring a clamping force, in print media, e.g. for adjusting the spacing in printing rollers or, in the case of food processing, e.g. for adjusting blades.

Furthermore, the results can be transferred to other actuators, e.g. electromagnetic, hydraulic and pneumatic actuators.

Corresponding to FIG. 12, the construction of an active vibration damping is intended to be explained, with integration of the actuator-sensor unit described in the invention.

The unit is fitted for this purpose between two elastic mechanical systems inter alia, e.g. in the form of a machine bearing. Alternatively, the combination with a passive bearing can also be advantageous or the unit is introduced as bearing element in an elastic structure (F. Döngi, Adaptive Structures in High Precision Satellites, Modelling and Control of Adaptive Mechanical Structures, Progress Reports, VDI, series 11, no. 268, p. 429 ff.).

The dynamic force present on the actuator-sensor unit is converted in the measurement amplifier 13 by evaluating the change in the small-signal resistance into a voltage proportional hereto.

The controller described here mainly comprises an integrating member 14 (A. Preumont, Vibration and Control of Active Structures, 2^{nd} Ed., Kluwer Academic Publishers, 2002). The application of other controllers is however likewise possible (D. Mayer, Control and identification of active mechanical structures with adaptive digital filters, Dissertation, TÜ Darmstadt, 2003).

The signal processed in the controller is subsequently amplified with a suitable power amplifier 15 for the (here: piezoelectric) actuator and the actuator is correspondingly actuated.

A particularly compact embodiment of the actuator-sensor unit is produced when using annular stack actuators (FIGS. 10 and 11) which are equipped correspondingly with sensing layers. The actuator is mechanically pre-tensioned by means of a led-through screw 12 (FIG. 11), the DLC sensor being able to be used for measuring the pre-tension.

During dynamic operation, the sensor can be used subsequently for measuring the forces present on the actuator-sensor unit. As long as the rigidity ratios between pre-tensioning screw 12 and actuator are chosen suitably, active vibration damping (e.g. corresponding to the above example) is also possible with this concept.

1. A force measuring device comprising an amorphous carbon layer which is disposed on a carrier and has piezoresistive properties.

2. The force measuring device according to claim 1 wherein the carrier comprises a solid actuator.

3. The force measuring device according to claim 2 wherein the solid actuator comprises a piezoelectric stack actuator.

4. The force measuring device according to claim 1 wherein the carrier comprises a metal carrier.

5. The force measuring device according to claim 1, characterised in that the carrier is a ceramic carrier.

6. The force measuring device according to claim 1 wherein the carrier comprises at least one of an electromagnetic actuator, a hydraulic actuator and a pneumatic actuator.

7. The force measuring device according to claim 1 wherein the amorphous carbon layer comprises at least one of a-C, a-:CH, i-CH, a-C:H:Me, DLC (diamond-like carbons), and Me:DLC.

8. The force measuring device according to claim 1 wherein the amorphous carbon layer comprises at least partially sp³-bonded carbon.

9. The force measuring device according to claim 1 wherein the thickness of the amorphous carbon layer is between about 0.1 and about 30 μm.

10. The force measuring device according to claim 1 wherein the amorphous carbon layer has a hardness of at least 10 GPa.

11. The force measuring device according to claim 1 wherein the amorphous carbon layer can be loaded thermally up to at least 150° C.

12. The force measuring device according to claim 1 wherein the amorphous carbon layer has a rigidity of less than 10 nm/kN.

13. The force measuring device according to claim 1 further comprising a metal layer disposed between the substrate and the amorphous carbon layer.

14. The force measuring device according to claim 13 further comprising at least one of an insulation layer and a wear protection layer disposed between the substrate and the metal layer.

15. The force measuring device according to claim 14 wherein the at least one of the insulation layer and the wear protection layer comprises at least one of AIN and Al₂O₃.

16. The force measuring device according to claim 1 further comprising local electrode structures applied on the amorphous carbon layer.

17. The force measuring device according to claim 1 further comprising a temperature sensor integrated into the force measuring device.

18. The force measuring device according to claim 16 wherein the local electrode structures are pre-structured on a foil.

19. The force measuring device according to claim 1 wherein the force measuring device is configured as a ring.

20. A method for measuring a force comprising disposing an amorphous carbon layer having piezoresistive properties on a carrier and effecting a resistance measurement of the amorphous carbon layer.

21. The method according to claim 20 wherein effecting a resistance measurement of the amorphous carbon layer comprises effecting a resistance measurement over the entire surface of the force measuring device.

22. The method according to claim 20 wherein effecting a resistance measurement of the amorphous carbon layer comprises effecting a resistance measurement of the amorphous carbon layer with local resolution.

23. A method for measuring a static force comprising disposing an amorphous carbon layer having piezoresistive properties on a carrier and effecting a resistance measurement of the amorphous carbon layer.

24. A method for measuring a dynamic force comprising disposing an amorphous carbon layer having piezoresistive properties on a carrier and effecting a resistance measurement of the amorphous carbon layer.

25. The method according to claim 20 wherein effecting a resistance measurement of the amorphous carbon layer comprises providing a metal layer between a substrate and the amorphous carbon layer, tapping the metal layer, and measuring current flow through the taps to the metal layer.

26. The method according to claim 20 wherein effecting a resistance measurement of the amorphous carbon layer comprises providing a metallic carrier for the amorphous carbon layer, tapping the metallic carrier, and measuring current flow through the taps to the metallic carrier.

27. A method of measuring a force on at least one of an active structure interface, a pre-tension-controlled roller bearing, a retaining force control, a machine tool, a printing roller, a damping device and an adjustment device, the method comprising disposing an amorphous carbon layer having piezoresistive properties on a carrier associated with the at least one of an active structure interface, pre-tension-controlled roller bearing, retaining force control, machine tool, printing roller, damping device and adjustment device, and effecting a resistance measurement of the amorphous carbon layer.

28. A method of measuring a force in an active vibration damping system, the method comprising disposing an amorphous carbon layer having piezoresistive properties on a carrier associated with the active vibration damping system, and effecting a resistance measurement of the amorphous carbon layer.

29. A method of measuring a force in at least one of a local force measuring cell and a force-sensing network, the method comprising disposing an amorphous carbon layer having piezoresistive properties on a carrier associated with the at least one of a local force measuring cell and a force-sensing network, and effecting a resistance measurement of the amorphous carbon layer.

30. The force measuring device according to claim 17 wherein the the temperature sensors is pre-structured on a foil.
